(19) United States
(12) Patent Application Publication
(10) Pub. No.: US 2026/0317007 A1
(43) Pub. Date: Oct. 15, 2026

(54) CONVENIENCE FOOD PACKAGING BOX

(71) Applicant: Wenwei GU, Shanghai (CN)

(72) Inventor: Wenwei GU, Shanghai (CN)

(73) Assignee: Wenwei GU, Shanghai (CN)

(21) Appl. No.: 19/164,003

(22) PCT Filed: Jan. 19, 2024
(86) PCT No.: PCT/CN2024/073180

§ 371 Date: Sep. 10, 2025

(30) Foreign Application Priority Data
Mar. 14, 2023 (CN) 202310246150.X

(51) Int. Cl. B65D 25/52; B65D 25/04; B65D 85/36; B65D 85/60

(52) U.S. Cl. CPC B65D 25/52; B65D 25/04; B65D 85/36; B65D 85/60

(57) ABSTRACT

The present disclosure discloses a convenience food packaging box, including a box body and a front end cover. The space in the packaging box is divided into a storage compartment and a quantitative discharging compartment, the storage compartment being matched to accommodate a plurality of solid food blocks, and the quantitative discharging compartment accommodating a predetermined number of solid food blocks; and an inner wall of the box body at the boundary between the storage compartment and the quantitative discharging compartment is provided with an elastic partition member, the center of the elastic partition member being provided with a material hole, and a hole diameter of the material hole being less than an outer diameter of the solid food block. When being static, the solid food blocks in the storage compartment are blocked by the elastic partition member and will not enter the quantitative discharging compartment; and when having certain momentum, the solid food blocks can break through the obstruction of the elastic partition member to enter the quantitative discharging compartment. The convenience food packaging box of the present disclosure has a unique structure, so that a user can take food by means of a simple and convenient operation, or even by one hand, thus solving the problems of convenience and sanitary safety.

### TECHNICAL FIELD

The present disclosure relates to a packaging box, and more particularly relates to a food packaging box.

### BACKGROUND ART

In today's daily life, many people have the habit of eating boxed snacks, including biscuits, chocolate, candy, and the like, even some people who live and work in a fast rhythm sometimes take these foods as a staple food. Based on this demand, boxed instant foods are becoming more and more popular, and higher safety and convenience requirements are also put forward for the boxed instant foods simultaneously.

In the prior art, there are many packaging boxes for boxed instant foods, wherein a food packaging box in the shape of a long cylinder is loved by people because of the portability thereof. However, such a packaging box also has a disadvantage in taking the food, namely, when the food at an opening part of the box is eaten up, the food at a rear part is required to be taken by means of dumping or finger reaching. On the one hand, it is inconvenient and a stable operation cannot be completed by one hand, and on the other hand, sanitary safety cannot be ensured in this way, especially after experiencing a serious epidemic situation, people are more worried about the sanitary safety of the daily diet.

### SUMMARY OF THE INVENTION

The technical problem to be solved by the present disclosure is to provide a convenience food packaging box having a unique structure, so that a user can take food by means of a simple and convenient operation, or even by one hand, thus solving the problems of convenience and sanitary safety.

In order to solve this technical problem, the technical solution adopted by the present disclosure is as follows:
a convenience food packaging box includes a box body and a front end cover and is used as an outer package of a solid food block, wherein space in the packaging box is divided into a storage compartment at a rear end and a quantitative discharging compartment at a front end, the storage compartment being matched to accommodate a plurality of solid food blocks, the quantitative discharging compartment accommodating a predetermined number of solid food blocks, and an outer end of the quantitative discharging compartment being provided with the front end cover capable of being opened and closed; and
an inner wall of the box body at the boundary between the storage compartment and the quantitative discharging compartment is provided with an elastic partition member, the center of the elastic partition member being provided with a material hole, and a hole diameter of the material hole being less than an outer diameter of the solid food block, when being static, the solid food blocks in the storage compartment are blocked by the elastic partition member and will not enter the quantitative discharging compartment; and when having certain momentum, the solid food blocks can break through the obstruction of the elastic partition member to enter the quantitative discharging compartment.

Further, the elastic partition member is a circle of elastic soft barrier fixedly provided on the inner wall of the box body.

Further, the elastic soft barrier is an annular rubber ring.

Further, the elastic soft barrier consists of a plurality of rubber protrusions which are uniformly distributed in a circle.

Further, an inner diameter of the quantitative discharging compartment is matched with an outer diameter of the solid food block.

Further, only one solid food block can be accommodated in the quantitative discharging compartment.

Further, the box body is in the shape of a long cylinder, an inner diameter of the storage compartment is matched with the inner diameter of the quantitative discharging compartment, or the inner diameter of the storage compartment is greater than the inner diameter of the quantitative discharging compartment.

Further, a quantitative compartment sleeve is also sleeved on a front section of the inner wall of the box body, and the elastic partition member is fixedly provided on an inner wall of the quantitative compartment sleeve by means of integral molding.

Further, a quantitative compartment sleeve is also sleeved on a front section of the inner wall of the box body, and the elastic partition member is fixedly provided on an inner wall of the quantitative compartment sleeve by means of integral molding.

Further, one end of the front end cover is connected to a front end of the box body.

The convenience food packaging box of the present disclosure has a unique structure, and in order to enable the user to conveniently and hygienically taking food from the packaging box in a quantitative manner, one quantitative discharging compartment is provided at an opening ingeniously as a “transfer compartment” for quantitative food taking, and a capacity of the discharging compartment may be set as a suitable food taking amount at a single time; and in this way, when the front end cover is opened each time, the user can take food very conveniently from the “transfer compartment” at the opening. Meanwhile, the unique elastic partition member is adopted to divide the space inside the box body into the quantitative discharging compartment at the front end and the remaining storage compartment. After the hole diameter of the material hole in the center of the elastic partition member is set in a matching manner, the following can be achieved: when being static, the solid food blocks in the storage compartment are blocked by the elastic partition member, and at this time, when the user opens the front end cover and pours food into the mouth, the food in the quantitative discharging compartment can be quickly and hygienically eaten. Meanwhile, due to the obstruction of the elastic partition member, the food in the storage compartment cannot fall out.

After taking food each time, the front end cover is closed, and at this time, the transfer compartment (the quantitative discharging compartment) is empty. At this time, the solid food block close to the material hole of the elastic partition member in the storage compartment can break through the obstruction of the elastic partition member to enter the quantitative discharging compartment when having certain momentum only by moving forwards slightly faster along a direction of the front end cover and then decelerating and stopping (or shaking back and forth); and when the quantitative discharging compartment is filled with the solid food blocks, the user can open the front end cover to take food.

This ingenious and unique structural design enables the food in the food packaging box to be sent to the quantitative discharging compartment at the front end in a quantitative manner time and time again, so that the user conveniently and hygienically take and eat the food. Meanwhile, this operation is so convenient that only shaking-uncovering-pouring into the mouth-covering is needed, and these actions can be completed easily by the user with one hand. Therefore, the convenience food packaging box of the present disclosure can enable people who do not want complicated operations to quickly and hygienically take food to the maximum extent. Especially in the current situation after the novel coronavirus is rampant worldwide, people are more and more accustomed to washing their hands thoroughly before eating, so that they feel away from the virus. However, more people are mobile phone users and computer users, and they are hard to be distracted to take food in a complicated manner when they are immersed in their lives, games, and work, while the food packaging box of the present disclosure can be operated by one hand.

However, the box body of the packaging box may be in the shape of a long cylinder, so that the best portability may be obtained, and it is most suitable for one hand to hold and operate in the work and games so as to supplement energy in a timely and quick manner; and the box body may also be of a large capacity type, that is, the storage compartment has a larger capacity, the inner diameter of the storage compartment is greater than the inner diameter of the quantitative discharging compartment, and at this time, the packaging box is in the shape of a wine bottle with a large belly and a small mouth, and this type of packaging box can obtain the maximum carrying capacity, so as to provide the user with the required energy supplementation at any time. While with regard to the large-capacity packaging box, the unique quantitative discharging compartment structure of the present disclosure can better highlight the hygiene and convenience in food taking, the food can be poured into the mouth at will after the front end cover is opened, without worrying about a large amount of food in the storage compartment slipping off (while for the food in the large-capacity packaging box in the prior art, when taking food, people must carefully pour the food into a plate or a clean palm of the hand to be careful not to spill the food behind, and if people want to pour the food directly into the mouth, people have to operate with both hands very carefully and even ask another companion beside to complete the operation). It is clear that the food packaging box of the present disclosure enables the food taking operation to be simple, convenient and extremely hygienic, and is believed to be more reassuring, convenient and safe for people in the post-epidemic period.

### BRIEF DESCRIPTION OF THE DRAWINGS

In order to enable the above objects, features and advantages of the present disclosure to be more apparent and understandable, the specific embodiments of the present disclosure will be described in detail below in conjunction with the accompanying drawings, in the drawings:

FIG. 1 is a first schematic structural diagram of a convenience food packaging box of the present disclosure, in which an inner diameter of a box body is matched with an outer diameter of a solid food block.

FIG. 2a is a schematic diagram of an elastic partition member being an annular rubber ring.

FIG. 2b is an enlarged diagram of a cross section A-A.

FIG. 3a is a schematic diagram of the elastic partition member being a circle of rubber protrusions.

FIG. 3b is an enlarged diagram of a cross section B-B.

FIG. 4 is a second schematic structural diagram of the convenience food packaging box of the present disclosure, in which the inner diameter of the box body is much greater than the outer diameter of the solid food block.

FIG. 5a is a schematic diagram of the elastic partition member being the annular rubber ring with a small material hole.

FIG. 5b is an enlarged diagram of a cross section C-C.

FIG. 6a is a schematic diagram of the elastic partition member being the annular rubber ring with the small material hole and with protrusions uniformly distributed on an inner edge of the material hole.

FIG. 6b is an enlarged diagram of a cross section D-D.

FIG. 7 is a schematic structural diagram of a quantitative compartment sleeve being sleeved on a front section of an inner wall of the box body.

FIG. 8 is a third schematic structural diagram of the convenience food packaging box of the present disclosure, in which the large-capacity packaging box has a relatively large storage compartment.

In the drawings:

| | |
|---|---|
| 1. food packaging box | 101. box body |
| 1011. quantitative compartment sleeve | 102. front end cover |
| 103. storage compartment | 104. quantitative discharging |
| | compartment |
| 105. elastic partition member | 1051. annular rubber ring |
| 10511. dividing groove | 1052. rubber protrusion |
| 1053. annular rubber ring with small | 106. material hole |
| material hole | |
| 2. solid food block | |

### DETAILED DESCRIPTION OF THE INVENTION

Hereinafter, the present disclosure will be described in further detail in conjunction with the accompanying drawings and examples.

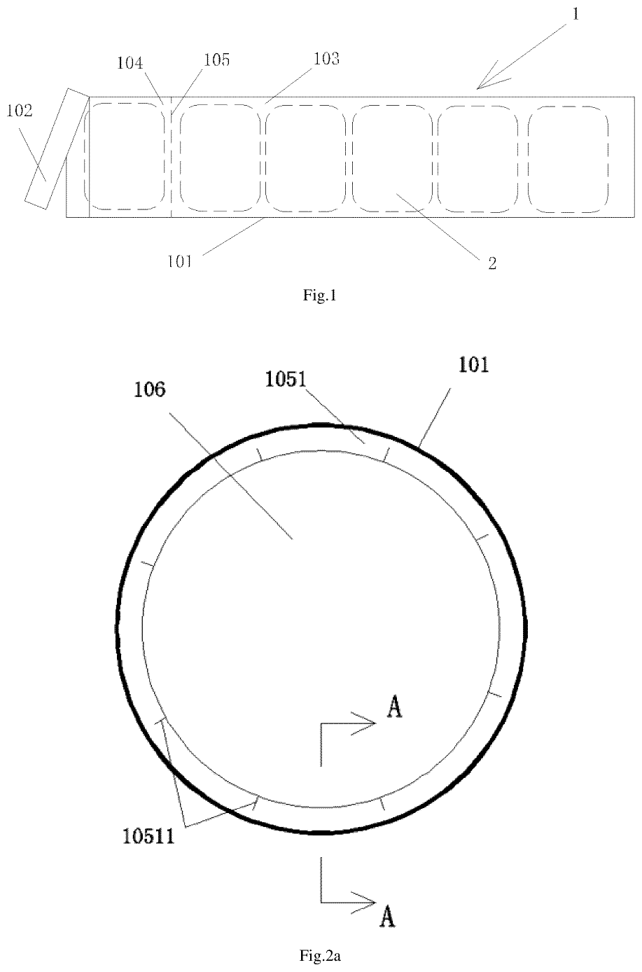

FIG. 1 shows a convenience food packaging box 1 having a main body in the shape of a long cylinder, including a box body 101 and a front end cover 102 and used as an outer package of a solid food block 2, wherein the solid food block 2 is in the shape of a cylinder or sphere, and an outer diameter of the solid food block 2 is matched with an inner diameter of the box body 101. Of course, the box body 101 may also have a triangular, square or polygonal cross section, and correspondingly, the solid food block 2 is in the shape of a prism or sphere, and the outer diameter of the solid food block 2 is matched with the inner diameter of the box body 101; and the solid food block 2 can smoothly move back and forth in the box body 101.

The space in the packaging box 1 is divided into a storage compartment 103 at a rear end and a quantitative discharging compartment 104 at a front end, the storage compartment 103 being matched to accommodate a plurality of solid food blocks 2, the quantitative discharging compartment 104 accommodating a predetermined number of solid food blocks 2 (which may be a predetermined number suitable for a user to take food at one time), and an outer end of the quantitative discharging compartment 104 being provided with the front end cover 102 capable of being opened and closed; and one end of the front end cover 102 is connected to a front end of the box body 101, so that the user can also easily close the front end cover 102 with one hand for operation after opening the front end cover 102 with one hand.

An inner wall of the box body 102 at the boundary between the storage compartment 103 and the quantitative discharging compartment 104 is provided with an elastic partition member 105, the center of the elastic partition member 105 being provided with a material hole 106, and a hole diameter of the material hole 106 being less than an outer diameter of the solid food block 2, so that only one solid food block 2 can pass through the elastic partition member 105 at one time. When being static, the solid food blocks 2 in the storage compartment 103 are blocked by the elastic partition member 105 and will not enter the quantitative discharging compartment 104; and when the user shakes the food packaging box 1 back and forth so that the solid food blocks 2 have certain forward momentum, the solid food blocks 2 can break through the obstruction of the elastic partition member 105 to enter the quantitative discharging compartment 104.

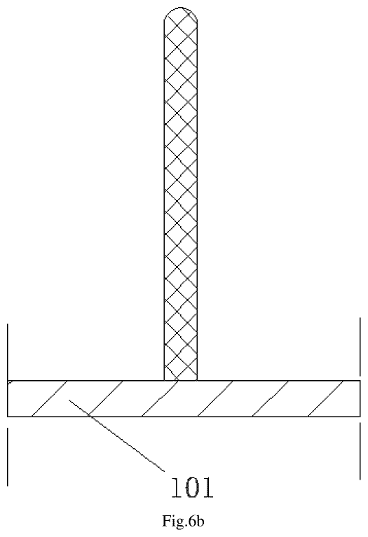

The inner wall of the box body 102 is provided with the elastic partition member 105 in such a manner that as shown in FIG. 7, a quantitative compartment sleeve 1011 is also sleeved on a front section of the inner wall of the box body 101, the quantitative compartment sleeve 1011 may be fixedly connected to the box body 101 by means of interference fit, and the like, or snap-in connection with axial limiting may also be adopted, the inner wall of the box body 101 may be provided with a step to better axially limit the quantitative compartment sleeve 1011, so as to avoid a capacity error of the quantitative discharging compartment 104 caused by inward movement of the quantitative compartment sleeve 1011.

The elastic partition member 105 is fixedly provided on an inner wall of the quantitative compartment sleeve 1011, the elastic partition member 105 and the quantitative compartment sleeve 1011 are manufactured by an integral molding process, and the quantitative compartment sleeve 1011 is made of a hard plastic material so as to be sleeved and inserted in the front section of the inner wall of the box body 101. Through this structural form, the quantitative compartment is more convenient and quick to manufacture. The quantitative compartment sleeve 1011 and the elastic partition member 105 which are integrally molded may be firstly manufactured according to capacity presetting, and then the quantitative compartment sleeve 1011 and the elastic partition member 105 are inserted into the front section of the box body 101 in a matching manner.

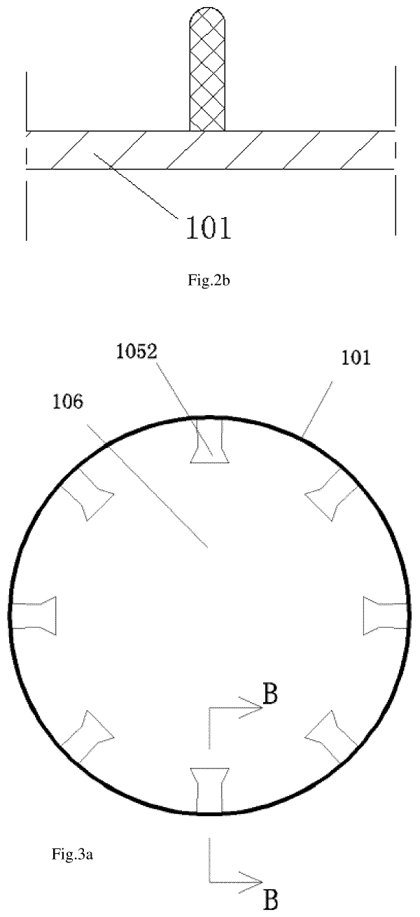

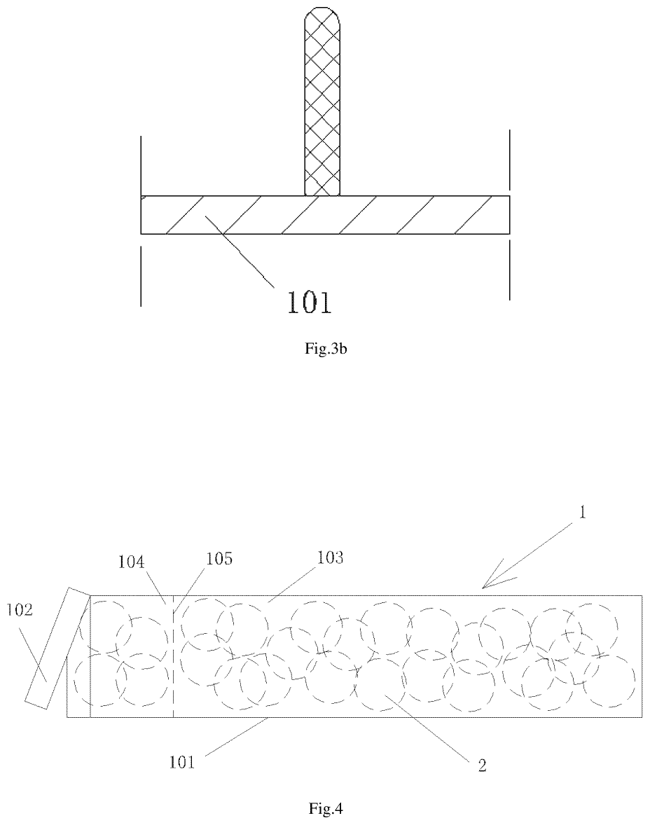

The predetermined capacity of the quantitative discharging compartment 104 may be a capacity for accommodating only one solid food block 2, or two or a predetermined number of solid food blocks 2, which may be determined according to actual demands and designs, and of course, more commonly, one or two solid food blocks 2 may be accommodated. The elastic partition member 105 is a circle of elastic soft barrier fixedly provided on the inner wall of the box body 101. The elastic soft barrier may be an annular rubber ring 1051 (food-grade silicone rubber), and as shown in FIG. 2a and FIG. 2b, an inner edge of the annular rubber ring 1051 may be provided with a radial dividing groove 10511 to obtain a suitable amount of elasticity, and the dividing groove 10511 may also be V-shaped with an inward opening. The elastic soft barrier may also consist of a plurality of rubber protrusions 1052 (food-grade silicone rubber) which are uniformly distributed in a circle, as shown in FIG. 3a and FIG. 3b. Of course, the elastic soft barrier in other forms may also be possible, as long as the elastic soft barrier can limit the solid food blocks 2 to randomly move between the storage compartment 103 and the quantitative discharging compartment 104. However, an elasticity coefficient of the elastic partition member 105 may be adjusted according to a single piece weight of the specific solid food block 2, so that the elastic partition member 105 can have the effect of blocking the solid food block 2 when the solid food block 2 is static, and when having sufficient momentum, the solid food block 2 can break through the obstruction of the elastic partition member 105 to enter the quantitative discharging compartment 104.

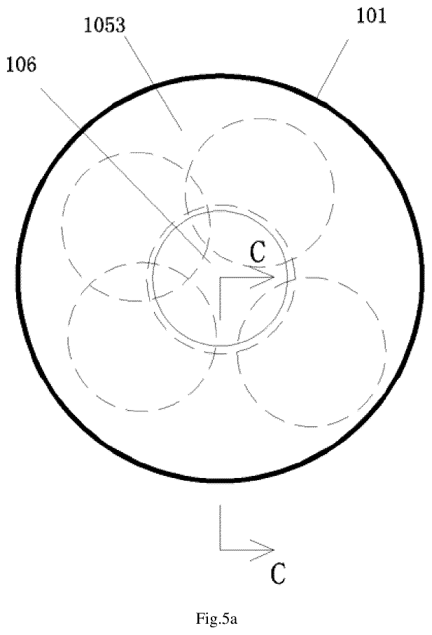

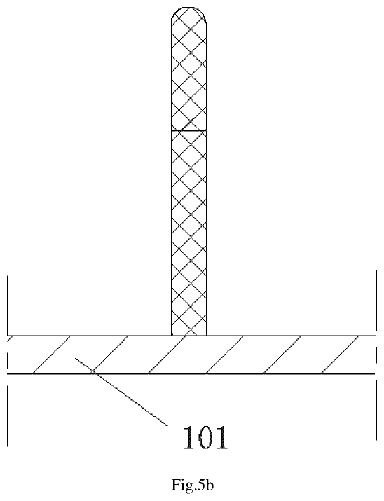

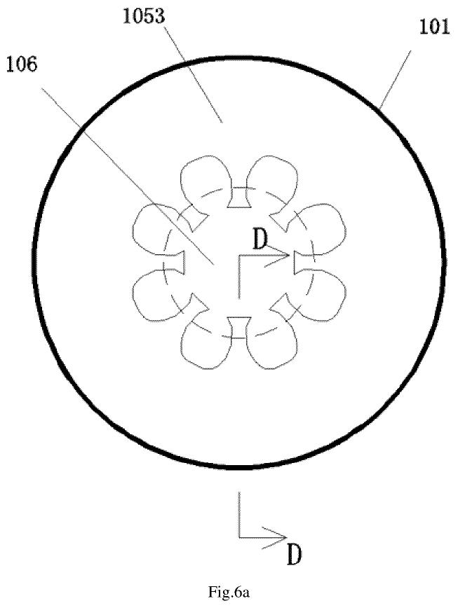

As another embodiment, as shown in FIG. 4, the main body of the convenience food packaging box 1 is similar to the above structure, while the inner diameter of the box body 101 may not be matched with the outer diameter of the solid food block 2, the inner diameter of the box body 101 is much greater than the outer diameter of the solid food block 2, and the outer diameters of the solid food blocks 2 are uniform. The capacity of the quantitative discharging compartment 104 is a predetermined number of a plurality of solid food blocks 2, and the hole diameter of the central material hole 106 of the elastic partition member 105 is relatively small and less than the outer diameter of the solid food block 2. As shown in FIG. 5a and FIG. 5b, the elastic soft barrier may be an annular rubber ring 1053 with a small material hole, an inner edge of the annular rubber ring with the small material hole may be provided with a radial dividing groove, or elastic protrusions are uniformly distributed on the inner edge of the annular rubber ring 1053 with the small material hole, as shown in FIG. 6a and FIG. 6b.

Likewise, when being static, the solid food blocks 2 in the storage compartment 103 are blocked by the elastic partition member 105 and will not enter the quantitative discharging compartment 104; and when the user shakes the food packaging box 1 back and forth so that the solid food blocks 2 have certain forward momentum, the solid food blocks 2 can break through the obstruction of the elastic partition member 105 to enter the quantitative discharging compartment 104, and after the solid food blocks 2 enter the quantitative discharging compartment 104 piece by piece to reach a predetermined number, the user may open the front end cover to pour and eat the solid food blocks 2 in the quantitative discharging compartment 104, thereby preventing excessive food from being poured out, also greatly facilitating food taking, and ensuring sanitary safety.

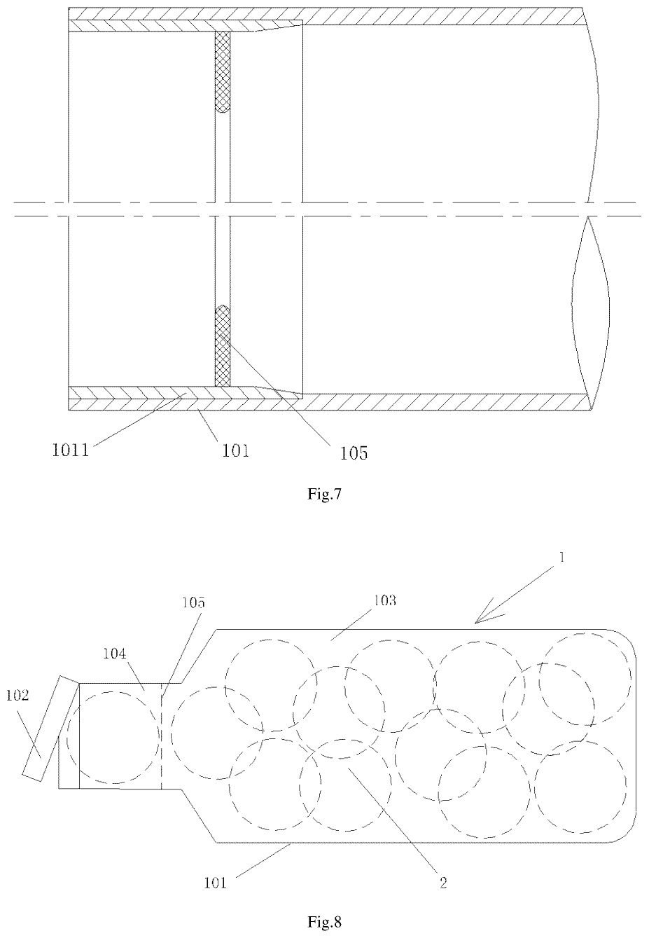

As yet another embodiment, as shown in FIG. 8, the convenience food packaging box is a large-capacity packaging box with the quantitative discharging compartment 104, the arrangement of the quantitative discharging compartment 104 and the elastic partition member 105 is consistent with that in the above embodiment, the capacity of the quantitative discharging compartment 104 is also the predetermined number suitable for the user to take food at one time, and the storage compartment 103 is in the form of having a greater inner diameter and a larger loading amount, namely, the main body of the packaging box is in the shape of a wine bottle with a large belly and a small mouth, so that the packaging box can provide the user with the required energy supplementation at any time, and the supplementation time of one box is longer. Of course, it is necessary to provide a guide section with a slope and a conical surface at a front end of the storage compartment 103 close to the quantitative discharging compartment 104, so that the solid food blocks 2 can be naturally concentrated at the position of the material hole 106 when entering the position of the front end, and the solid food blocks 2 in the storage compartment 103 can smoothly enter the quantitative discharging compartment 104 when the user shakes the packaging box for taking food.

The bottle-shaped large-capacity packaging box with the quantitative discharging compartment 104 structure in such an embodiment can better highlight the hygiene and convenience in taking food from the large-capacity packaging box, the food can be poured into the mouth at will after the front end cover 102 is opened, without worrying about a large amount of food in the storage compartment 103 slipping off, while for the food in the large-capacity packaging box in the prior art, when taking food, people must carefully pour the food into a plate or a clean palm of the hand to be careful not to spill the food behind and then take food, which is cumbersome and unsanitary and inevitably causes the phenomenon of food scattering. However, if people want to pour the food directly into the mouth, people have to operate with both hands very carefully and even ask another companion beside to complete the operation, which is more likely to cause the embarrassing situations such as over-pouring and scattering all over the ground. It is clear that the food packaging box in such an embodiment enables the food taking operation on the large-capacity packaging box to be simple, convenient and extremely hygienic, and is believed to be more reassuring, convenient and safe for people in the post-epidemic period. The above description is merely specific embodiments of the present disclosure. However, the scope of protection of the present disclosure is not limited to this, those skilled in the art can readily conceive changes or substitutions within the technical scope disclosed by the present disclosure, and these changes or substitutions should be covered within the scope of protection of the present disclosure. Therefore, the scope of protection of the present disclosure shall be determined by the scope of protection of the claims as stated.

What is claimed is:

1. A convenience food packaging box comprising a box body and a front end cover and used as an outer package of a solid food block, wherein space in the packaging box is divided into a storage compartment at a rear end and a quantitative discharging compartment at a front end, the storage compartment being matched to accommodate a plurality of solid food blocks, the quantitative discharging compartment accommodating a predetermined number of solid food blocks, and an outer end of the quantitative discharging compartment being provided with the front end cover capable of being opened and closed; and
an inner wall of the box body at the boundary between the storage compartment and the quantitative discharging compartment is provided with an elastic partition member, the center of the elastic partition member being provided with a material hole, and a hole diameter of the material hole being less than an outer diameter of the solid food block, when being static, the solid food blocks in the storage compartment are blocked by the elastic partition member and will not enter the quantitative discharging compartment; and
when having certain momentum, the solid food blocks can break through the obstruction of the elastic partition member to enter the quantitative discharging compartment.

2. The food packaging box according to claim 1, wherein the elastic partition member is a circle of elastic soft barrier fixedly provided on the inner wall of the box body.

3. The food packaging box according to claim 2, wherein the elastic soft barrier is an annular rubber ring.

4. The food packaging box according to claim 2, wherein the elastic soft barrier consists of a plurality of rubber protrusions which are uniformly distributed in a circle.

5. The food packaging box according to claim 1, wherein an inner diameter of the quantitative discharging compartment is matched with an outer diameter of the solid food block.

6. The food packaging box according to claim 5, wherein only one solid food block can be accommodated in the quantitative discharging compartment.

7. The food packaging box according to claim 1, wherein the box body is in the shape of a long cylinder, an inner diameter of the storage compartment is matched with the inner diameter of the quantitative discharging compartment, or the inner diameter of the storage compartment is greater than the inner diameter of the quantitative discharging compartment.

8. The food packaging box according to claim 1, wherein a quantitative compartment sleeve is also sleeved on a front section of the inner wall of the box body, and the elastic partition member is fixedly provided on an inner wall of the quantitative compartment sleeve by means of integral molding.

9. The food packaging box according to claim 5, wherein a quantitative compartment sleeve is also sleeved on a front section of the inner wall of the box body, and the elastic partition member is fixedly provided on an inner wall of the quantitative compartment sleeve by means of integral molding.

10. The food packaging box according to claim 1, wherein one end of the front end cover is connected to a front end of the box body.
